(19) United States
(12) Patent Application Publication
(10) Pub. No.: US 2016/0213187 A1
(43) Pub. Date: Jul. 28, 2016

(54) METHOD FOR OPERATING AN APPLIANCE IN A SABBATH OPERATING MODE

(71) Applicant: General Electric Company, Schenectady, NY (US)

(72) Inventors: Eric Xavier Meusburger, Louisville, KY (US); Robert John Zanelli, Louisville, KY (US)

(21) Appl. No.: 14/606,094

(22) Filed: Jan. 27, 2015

(51) Int. Cl. A47G 35/00; H05B 1/02

(52) U.S. Cl. CPC A47G 35/00; H05B 1/0263; H05B 1/0266

(57) ABSTRACT

A method for operating an appliance. The method includes establishing a current date and time of day and automatically shifting the appliance to a Sabbath operating mode when the current date and time of day is Sabbath. A related appliance having a controller that is configured for automatically shifting the appliance to a Sabbath operating mode when a current date and time of day of a clock corresponds to Sabbath is also provided.

### FIELD OF THE INVENTION

The present subject matter relates generally to methods and systems for operating appliances. The present subject matter also relates to methods and systems for operating appliances during Sabbath.

### BACKGROUND OF THE INVENTION

Appliances may include features that require work to operate during Sabbath or Shabbat. Thus, appliances can include a Sabbath mode that prevents the appliance from performing certain functions while also permitting operation of the appliances during Sabbath. Generally, a user manually activates the Sabbath mode with a user input of the appliances.

Appliances with Sabbath mode can suffer certain drawbacks. For example, the user of the appliance must generally remember to activate the Sabbath mode prior to a start of Sabbath, and remembering to activate the Sabbath mode can be difficult. In addition, activating the Sabbath mode on multiple appliances can be tedious and time consuming. If the user forgets to activate the Sabbath mode on one or more appliances prior to Sabbath, the user may not be permitted to interact with or use the appliance until Sabbath ends, and the user may be greatly inconvenienced without access to an appliance throughout Sabbath.

Accordingly, a method for operating an appliance that assists with operating the appliance in a Sabbath mode would be useful.

### BRIEF DESCRIPTION OF THE INVENTION

The present subject matter provides a method for operating an appliance. The method includes establishing a current date and time of day and automatically shifting the appliance to a Sabbath operating mode when the current date and time of day is Sabbath. A related appliance having a controller that is configured for automatically shifting the appliance to a Sabbath operating mode when a current date and time of day of a clock corresponds to Sabbath is also provided. Additional aspects and advantages of the invention will be set forth in part in the following description, or may be apparent from the description, or may be learned through practice of the invention.

In a first exemplary embodiment, a method for operating an appliance is provided. The method includes establishing a current date and time of day in a controller of the appliance and automatically shifting the appliance to a Sabbath operating mode with the controller of the appliance when the current date and time of day in the controller of the appliance is Sabbath.

In a second exemplary embodiment, an appliance is provided. The appliance includes a clock configured for tracking a current date and time of day. A network interface is configured for establishing communication with a network. A controller is in operative communication with the clock and the network interface. The controller is configured for setting the current date and time of day for the clock based at least in part upon a date and time received from the network. The controller is also configured for automatically shifting the appliance to a Sabbath operating mode when the current date and time of day of the clock corresponds to Sabbath.

In a third exemplary embodiment, a method for operating an appliance is provided. The method includes connecting the appliance to a server with a network, transmitting a Sabbath operating mode initiation signal from the server to the appliance with the network when a current date and time of day at the appliance corresponds to Sabbath, and shifting the appliance to a Sabbath operating mode in response to receiving the Sabbath operating mode initiation signal at the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a system for assisting with operating an appliance in a Sabbath operating mode according to an exemplary embodiment of the present subject matter.

FIG. 2 illustrates a method for operating an appliance in a Sabbath operating mode according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

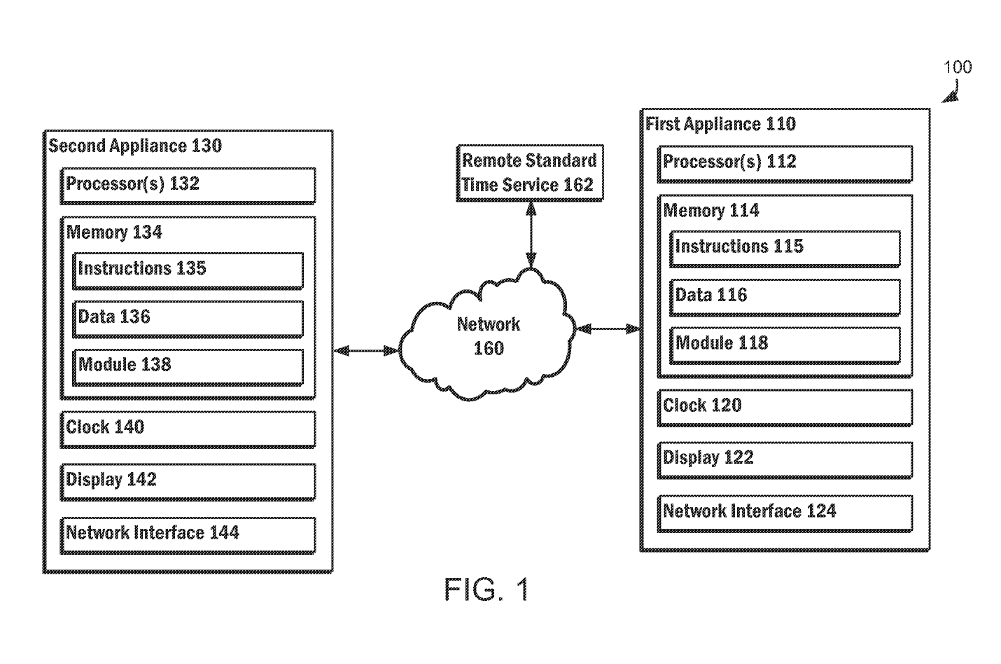

FIG. 1 provides a schematic view of a system 100 for assisting with operating an appliance in a Sabbath operating mode according to an exemplary embodiment of the present subject matter. System 100 includes a first appliance 110, a second appliance 130, and a network 160. First appliance 110 and second appliance 130 are in communication with one another via network 160. In alternative exemplary embodiments, system 100 may include additional appliances, e.g., one additional appliance, two additional appliances, three additional appliances or more additional appliances, that communicate with one another and first and second appliance 110, 130 via network 160. Appliances of system 100, including first appliance 110 and second appliance 130, may be positioned within a single building or house, e.g., within a common room in the house. As discussed in greater detail below, system 100 includes features for automatically shifting first appliance 110 and/or second appliance 130 to a Sabbath operating mode when a current date and time of day is or corresponds to Sabbath.

As will be understood by those skilled in the art, system 100 has peer-to-peer architecture in the exemplary embodiment presented in FIG. 1. However, the exemplary embodiment presented in FIG. 1 is provided by way of example only. In alternative exemplary embodiments, system 100 can be implemented using other suitable architectures, such as client-server architecture. Thus, e.g., first and second appliance 110, 130 may communication with each other over network 160 via a server.

First appliance 110 includes one or more processors 112, a memory 114, and a network interface 124. As used herein, an appliance can be any machine or device for performing a specific task that also includes features for operating in a Sabbath operation mode, including, without limitation, a clothes dryer, a clothes washer, a dishwasher, a refrigerator, a stove, an oven, an HVAC system controller or programmable thermostat, a security system or any other suitable appliance.

Network interface 124 of first appliance 110 can include any suitable components for interfacing with one more networks, such as network 160. For example, network interface 124 of first appliance 110 may include transmitters, receivers, ports, controllers, antennas, or other suitable components.

The processor(s) 112 of first appliance 110 can be any suitable processing device, such as a microprocessor, microcontroller, integrated circuit, or other suitable processing device. The memory 114 of first appliance 110 can include any suitable computing system or media, including, but not limited to, non-transitory computer-readable media, RAM, ROM, hard drives, flash drives, or other memory devices. The memory 114 of first appliance 110 can store information accessible by processor(s) 112 of first appliance 110, including instructions 115 that can be executed by processor(s) 112 of first appliance 110 to control various components of first appliance 110 to provide appliance functionality and data 116. Thus, the combination of one or more processors 112 and memory 114 may correspond to a controller configured to implement various programs or methods to operate first appliance 110.

A module 118 is included or stored in memory 114 of first appliance 110. It will be appreciated that the term “module” refers to computer logic utilized to provide desired functionality. Thus, a module can be implemented in hardware, application specific circuits, firmware and/or software controlling a general purpose processor. In one embodiment, modules are program code files stored on the storage device, loaded into memory and executed by a processor or can be provided from computer program products, for example computer executable instructions, that are stored in a tangible computer-readable storage medium such as RAM, hard disk or optical or magnetic media. Thus, while module 118 is shown stored in memory 114 of first appliance 110 in the exemplary embodiment shown in FIG. 1, module 118 may be stored in or implemented by any other suitable component of system 100 in alternative exemplary embodiments.

As may be seen in FIG. 1, first appliance 110 also includes a clock 120 and a display 122. Clock 120 may be any suitable type of time keeping mechanism. For example, clock 120 may be a real time clock integrated within a control board of first appliance 110. Clock 120 is configured for keep current date and time such that the current time may be presented on display 122 of first appliance 110. Thus, display 122 may be any suitable type of mechanism for visually presenting the current time to a user of first appliance 110. For example, display 122 may be a liquid crystal display (LCD), a vacuum fluorescent display (VFD), a series of seven-segment displays, an array of light emitting diodes (LEDs), etc. Clock 120 of first appliance 110 may keep track of the current time, and the current time may be presented to the user of first appliance 110 on display 122.

Second appliance 130 includes similar features and components as first appliance 110. For example, second appliance 130 includes one or more processors 132, a memory 134, instructions 135, data 136, at least one module 138, a clock 140, a display 142 and a network interface 144. The one or more processors 132, memory 134, instructions 135, data 136, module 138, clock 140, display 142 and network interface 144 may be constructed of or with the same or similar components described above for the corresponding elements of first appliance 110.

First and second appliances 110, 130 may be any suitable types of appliances and combination of appliances. Thus, it will be understood that while first appliance 110 and second appliance 130 may share similar or common components, first appliance 110 and second appliance 130 may be different types appliances, in certain exemplary embodiments. For example, first appliance 110 may be a range appliance, and second appliance 130 may be an over-the-range microwave appliance. In alternative exemplary embodiments, first and second appliances 110, 130 may be the same type of appliances. For example, both first and second appliances 110, 130 may be oven appliances.

System 100 may also include a server (such as a wireless hub or a remote server) and a client for assisting with regulating operation of first and second appliances 110, 130. Each of the server and client may include one or more processors and a memory, e.g., the same or similar type of processors and memory described above for first appliance 110. The memory of the server and client can store information accessible by processor(s) of the server and client that can be executed by processor(s) of the server and client to control various components of first and second appliance 110, 130. The client can be any suitable type of computing device, such as a general purpose computer, special purpose computer, laptop, desktop, integrated circuit, mobile device, smartphone, tablet, wearable computing device, or other suitable computing device. Thus, a user of first and second appliances 110, 130 may regulate operation of first and second appliances 110, 130 remotely with the client via the server.

As discussed above, first appliance 110 and second appliance 130 are in communication with one another via network 160. The network 160 can be any type of communications network, such as a local area network (e.g. intranet), wide area network (e.g. Internet), or some combination thereof. The network 160 can also include a direct connection between first appliance 110 and second appliance 130. In general, communication between first appliance 110 and second appliance 130 can be carried via the network interface using any type of wired and/or wireless connection, using a variety of communication protocols (e.g. TCP/IP, HTTP), encodings or formats (e.g. HTML, XML), and/or protection schemes (e.g. VPN, secure HTTP, SSL).

As discussed in greater detail below, first appliance 110 and/or second appliance 130 may be configured such that first and second appliance 110, 130 automatically shift to a Sabbath operating mode when the current date and time of day is Sabbath. Thus, clock 120 of first appliance 110 and clock 140 of second appliance 130 may be configured for tracking the current date and time of day in order to establish when the current date and time of day is Sabbath. First appliance 110 and/or second appliance 130 may also be configured such that first and second appliance 110, 130 automatically adjust to a non-Sabbath operating mode when the current date and time of day does not correspond to Sabbath.

In the Sabbath operating mode, first and second appliances 110, 130 are configured or programmed to avoid work (e.g., as defined by Jewish law). Thus, first and second appliances 110, 130 may be configured or programmed to avoid bishul, molid, and/or igniting or extinguishing a fire.

First and second appliance 110, 130 may operate in any suitable manner in the Sabbath operating mode. For example, first appliance 110 and/or second appliance 130 may be configured or programmed to operate in the manner described in U.S. Pat. No. 5,808,278 of Moon et al. entitled “Electronic Appliance and a Sabbath Mode Therefor,” which is hereby incorporated by reference in its entirety for all purposes, in the Sabbath operating mode. As another example, if first appliance 110 includes a light fixture within first appliance 110, the light fixture within first appliance 110 may be disabled in the Sabbath operating mode, e.g., in order to avoid lighting or extinguishing a fire. As another example, heating elements of first appliance 110 may be automatically activated to a temperature sufficient to only keep food warm in the Sabbath operating mode, e.g., in order to avoid bishul or cooking food. As additional examples, display 122 or audible alarms/notifications of first appliance 110 may be deactivated and/or user inputs of first appliance 110 may be deactivated or reprogrammed in the Sabbath operating mode.

It will be understood that the examples provides above are not intended to limit the present subject matter in any aspect and are intended only to provide examples of how first appliance 110 and/or second appliance 130 may operate in the Sabbath operating mode. Any other suitable feature of first and second appliance 110, 130 may be disabled or reconfigured in the Sabbath operating mode in alternative exemplary embodiments, e.g., in order to keep Sabbath and/or avoid breaking Jewish law.

System 100 may also assist with synchronizing the various clocks of the appliances of system 100, such as clock 120 of first appliance 110 and clock 140 of second appliance 130. As an example, a user of system 100 may utilize a user input, such as a touch screen, buttons, dials, etc., of first appliance 110 to manually establish the current time of day at first appliance 110, and first appliance 110 may transit the current time of day to other appliances of system 100, such as second appliance 130, via network 160. As another example, network 160 (e.g., the server of system 100) may receive the current time of day from a remote standard time service 162, such as an online atomic clock or time.gov, and network 160 may communicate the current time of day to each appliance of system 100, such as first and second appliance 110, 130. Thus, clock 120 of first appliance 110 and clock 140 of second appliance 130 may be synchronized to a common time.

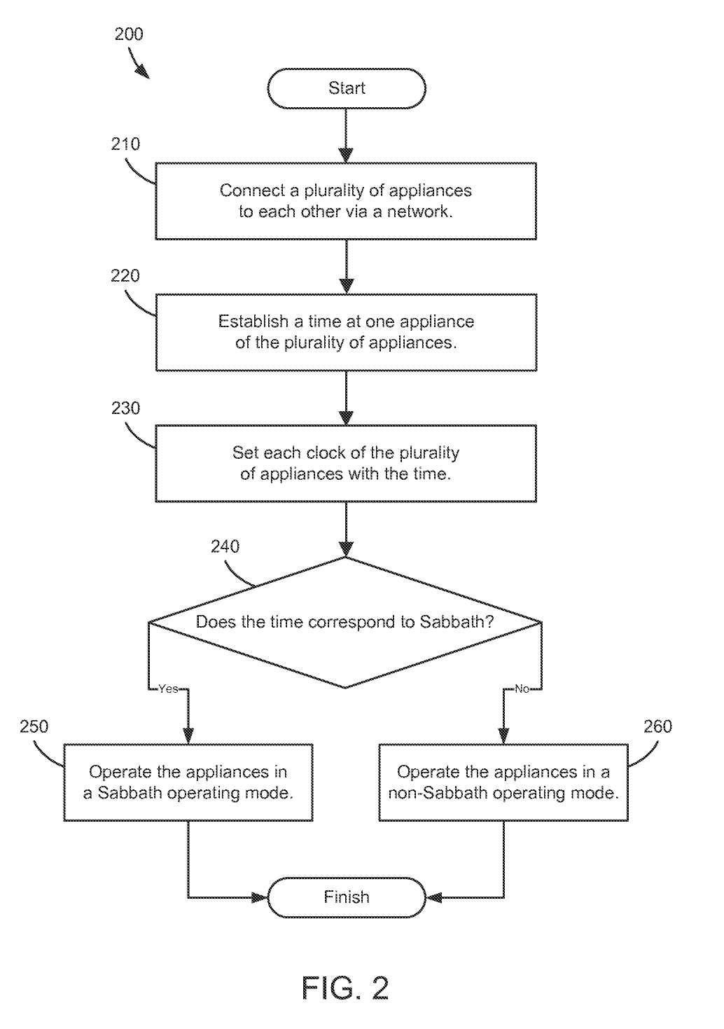

FIG. 2 illustrates a method 200 for operating an appliance in a Sabbath operating mode according to an exemplary embodiment of the present subject matter. Method 200 can be used to operate any suitable appliance or system of appliances. For example, method 200 may be used with system 100 (FIG. 1). In particular, utilizing method 200, an appliance of system 100, such as first appliance 110 and/or second appliance 130, are automatically shifted to a Sabbath operating mode when a clock of the appliance corresponds to Sabbath, as discussed in greater detail below.

At step 210, first and second appliance 110, 130 are connected to each other with network 160. For example, first appliance 110 may connect to network 160 with network interface 124 of first appliance 110, and second appliance 130 may connect to network 160 with network interface 144 of second appliance 130. As discussed above, network 160 may be a wireless network, such as a Wi-Fi or Bluetooth network.

At step 220, a current time of day is established, e.g., at one of first appliance 110 and second appliance 130. As an example, a user of system 100 may manually enter the current time of day with a user input of first appliance 110 or a user input of second appliance 130. As another example, network 160 may connect to remote standard time service 162 and receiving the current time of day from remote standard time service 162 via network 160. Thus, clock 120 of first appliance 110 and clock 140 of second appliance 130 may be synchronized to a clock at remote standard time service 162 via network 160. As another example, system 100 may determine the current date and time of day by referencing a clock within the server of system 100 at step 220. With the current time of day established at step 220, each clock of the appliances of system 100 may be set or synchronized with the current time of day, e.g., via network 160, at step 230.

At step 240, it is determined whether the current time of day, e.g., from step 220, is or corresponds to Sabbath. If the current date and time of day correspond to Sabbath at step 240 then at least one appliance of system 100 is operated in the Sabbath operating mode at step 250. Conversely, if the current date and time of day do not correspond to Sabbath at step 240 then the appliances of system 100 are operated normally or not in the Sabbath operating mode.

At step 250, at least one appliance of system 100, such as first appliance 110 and/or second appliance 130, is automatically shifted to the Sabbath operating mode when the current date and time of day in a clock of the appliance is Sabbath. As an example, a controller of first appliance 110 may be configured or programmed to automatically shift first appliance 110 to the Sabbath operating mode when the current date and time of day in clock 120 of first appliance 110 is or corresponds to Sabbath. As another example, the server of system 100 may signal first appliance 110 via network 160 to shift to the Sabbath operating mode when the current date and time of day is or corresponds to Sabbath, and first appliance 100 may automatically shift to the Sabbath operating mode in response to such signal. As discussed above, various features of first appliance 110 may be deactivated or reprogrammed in the Sabbath operating mode, e.g., in order to avoid doing work or otherwise violate Jewish law.

At step 260, the appliances of system 100, such as first appliance 110 and second appliance 130, are automatically shifted to the non-Sabbath operating mode when the current date and time of day in a clock of the appliance does not correspond to Sabbath. As an example, the controller of first appliance 110 may be configured or programmed to automatically shift first appliance 110 to the non-Sabbath operating mode when the current date and time of day in clock 120 of first appliance 110 does not correspond to Sabbath. As another example, the server of system 100 may signal first appliance 110 via network 160 to shift to the non-Sabbath operating mode when the current date and time of day does not correspond to Sabbath, and first appliance 100 may automatically shift to the non-Sabbath operating mode in response to such signal.

Method 200 may assist with conveniently and automatically activating the Sabbath operating mode of an associated appliance. Thus, a user may avoid having to manually engage the Sabbath operating mode. In addition, method 200 may assist with automatically activating the Sabbath operating mode in all appliances of system 100 such that the user does not have to manually activate the Sabbath operating mode in each appliance of system 100. It should be understood that a user of an appliance configured to implement method 200 may disable or override method 200, e.g., when the user does not desire operation of the appliance in the Sabbath operating mode.

Method 200 may include additional steps or features. In particular, power failures can occur at various times, including during Sabbath. Thus, method 200 may include determining whether an appliance of system 100 was operating in the non-Sabbath operating mode or the Sabbath operating mode prior to a power interruption. Method 200 may also include automatically adjusting the appliance to the non-Sabbath operating mode if the appliance was operating in the non-Sabbath operating mode prior to the power interruption or to the Sabbath operating mode if the appliance was operating in the Sabbath operating mode prior to the power interruption. In such a manner, operations or features of appliances that are considered work or otherwise violate Jewish law may be avoided despite power outages. Method 200 may also include automatically adjusting the appliance to the non-Sabbath operating mode if the appliance was operating in the Sabbath operating mode prior to the power interruption and the power interruption did not exceed a predetermined period of time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating an appliance, comprising:
establishing a current date and time of day in a controller of the appliance; and
automatically shifting the appliance to a Sabbath operating mode with the controller of the appliance when the current date and time of day in the controller of the appliance is Sabbath.

2. The method of claim 1, further comprising connecting the appliance a network, said step of establishing comprising receiving the current date and time of day from the network at the controller of the appliance.

3. The method of claim 2, wherein said step of establishing comprises receiving the current date and time of day from a standard time service at the controller of the appliance via the network.

4. The method of claim 2, wherein said step of establishing comprises synchronizing a real time clock of the controller of the appliance with the current date and time of day from the network.

5. The method of claim 1, wherein said step of establishing comprises manually entering the current date and time of day with a user input of the appliance.

6. The method of claim 1, further comprising automatically adjusting the appliance to a non-Sabbath operating mode with the controller of the appliance when the current date and time of day in the controller of the appliance is not Sabbath.

7. The method of claim 1, wherein said step of automatically shifting comprises automatically shifting the appliance to the Sabbath operating mode with the controller of the appliance when the current date and time of day in a real time clock of the controller is Sabbath.

8. The method of claim 1, further comprising:
determining whether the appliance was operating in a non-Sabbath operating mode or the Sabbath operating mode prior to a power interruption with the controller of the appliance; and
automatically adjusting the appliance to the non-Sabbath operating mode with the controller of the appliance if the appliance was operating in the non-Sabbath operating mode prior to the power interruption or to the Sabbath operating mode with the controller of the appliance if the appliance was operating in the Sabbath operating mode prior to the power interruption.

9. The method of claim 1, wherein the appliance is a refrigerator appliance, a range appliance, an oven appliance, a microwave appliance or a dishwasher appliance.

10. The method of claim 1, wherein a current operating state of a light fixture of the appliance is fixed when the appliance shifts to the Sabbath operating mode.

11. An appliance, comprising:
a clock configured for tracking a current date and time of day;
a network interface configured for establishing communication with a network; and
a controller in operative communication with the clock and the network interface, the controller configured for setting the current date and time of day for the clock based at least in part upon a date and time received from the network, the controller also configured for automatically shifting the appliance to a Sabbath operating mode when the current date and time of day of the clock corresponds to Sabbath.

12. The appliance of claim 11, wherein the clock is a real time clock and the controller sets the current date and time of day of the real time clock with a date and time from a standard time service via the network.

13. The appliance of claim 11, wherein the controller is further configured for automatically adjusting the appliance to a non-Sabbath operating mode when the current date and time of day of the clock does not correspond to Sabbath.

14. The appliance of claim 11, wherein the controller is further configured for determining whether the appliance was operating in a non-Sabbath operating mode or the Sabbath operating mode prior to a power interruption and automatically adjusting the appliance to the non-Sabbath operating mode if the appliance was operating in the non-Sabbath operating mode prior to the power interruption or to the Sabbath operating mode if the appliance was operating in the Sabbath operating mode prior to the power interruption.

15. The appliance of claim 11, wherein the appliance is a refrigerator appliance, a range appliance, an oven appliance, a microwave appliance or a dishwasher appliance.

16. The appliance of claim 11, further comprising a light fixture, the controller configured for maintaining a current operating state of the light fixture when the appliance is operating in the Sabbath operating mode.

17. The appliance of claim 11, further comprising an audible alarm, the controller configured for deactivating the audible alarm when the appliance is operating in the Sabbath operating mode.

18. The appliance of claim 11, further comprising a control panel with a plurality of user inputs, the controller configured for reprogramming the control panel when the appliance is operating in the Sabbath operating mode.

19. A method for operating an appliance, comprising:
connecting the appliance to a server with a network;
transmitting a Sabbath operating mode initiation signal from the server to the appliance with the network when a current date and time of day at the appliance corresponds to Sabbath; and
shifting the appliance to a Sabbath operating mode in response to receiving the Sabbath operating mode initiation signal at the appliance.

20. The method of claim 19, further comprising:
transmitting a Sabbath operating mode stop signal from the server to the appliance with the network when the current date and time of day at the appliance does not correspond to Sabbath; and
shifting the appliance to a non-Sabbath operating mode in response to receiving the Sabbath operating mode stop signal at the appliance.
